(19) United States
(12) Patent Application Publication
(10) Pub. No.: US 2015/0365840 A1
(43) Pub. Date: Dec. 17, 2015

(54) Methods and Apparatus for Discovery Resource Signaling

(71) Applicant: Nokia Technologies Oy, Espoo (FI)

(72) Inventors: Weidong Yang, Hoffman Estates, IL (US); Esa Tiirola, Oulu (FI); Juha Korhonen, Espoo (FI)

(21) Appl. No.: 14/742,553

(22) Filed: Jun. 17, 2015

Related U.S. Application Data
(60) Provisional application No. 62/013,243, filed on Jun. 17, 2014.

(51) Int. Cl. H04W 24/10; H04W 8/00

(52) U.S. Cl. CPC H04W 24/10; H04W 8/005; H04W 88/02

(57) ABSTRACT

In accordance with an example embodiment of the present invention, a transmission pattern is determined for a user equipment operating in device to device communication, wherein the transmission pattern is obtained from a dictionary of transmission patterns consisting of patterns of a combinatorial design in an ordered list such that a pattern representing a smallest integer from all patterns of the combinatorial design is provided first followed by all consecutive cyclic shifts of the pattern representing the smallest integer followed subsequently by next patterns representing a smallest integer from all patterns of the combinatorial design not already in the ordered list and their respective consecutive cyclic shifts.

### CROSS REFERENCE TO RELATED APPLICATIONS

This application claims priority to U.S. Provisional Application No. 62/013,243, filed on Jun. 17, 2014. The entire contents of this earlier filed application are hereby incorporated by reference in its entirety.

### TECHNICAL FIELD

The present invention relates generally to wireless communication. More particularly, the invention relates to improved systems and techniques for discovery signaling in device to device communication.

### DEFINITION OF ABBREVIATIONS

The following definitions will assist in understanding various abbreviations used in this application:

D2D Device to device

### eNB Enhanced Node B

LTE Long term evolution

### M-BCH Modified BCH

NMC Number of minimum copies received

### PRB Physical Resource Block

### RAN Radio Access Network

### Rel Release

### RRC Radio Resource Control

### Rx Reception

### SIB System Information Block

### SQS Steiner Quadruple Systems

### STS Steiner Triple Systems

### TTI Transmission Time Instant

### Tx Transmission

### Tx Pattern Transmit Pattern

### UE User Equipment

### BACKGROUND

Device to device communication is becoming more and more widespread in wireless communication networks, and is a feature of increasing importance and interest in networks following 3GPP LTE and LTE-A specifications. An important aspect of such communication is the development of mechanisms for discovery, including the design of discovery signaling. The following types of device to device (D2D) discovery are defined in 3GPP specification TR 36.843:

Type 1: a discovery procedure where resources for discovery signal transmission are allocated on a non UE specific basis. It should be appreciated that all the resources may be for all UEs or group of UEs.

Type 2: a discovery procedure where resources for discovery signal transmission are allocated on a per UE specific basis. The Type 2 procedure is further subdivided into Type 2A and Type 2B.

Type 2A: Resources are allocated for each specific transmission instance of discovery signals.

Type 2B: Resources are semi-persistently allocated for discovery signal transmission.

A UE using Type 2B signaling transmits a discovery signal using specified resources, such as time divisions, and when not transmitting the UE listens for discovery signals from other UEs. Type 2B signaling follows a pattern of resources to be used, including transmission and/or reception times, and various considerations need to be taken into account in designing an optimum pattern.

### SUMMARY

Various aspects of examples of the invention re set out in the claims.

According to a first aspect of the present invention there is disclosed, at least one processor; and at least one memory including computer program code, wherein the at least one memory and the computer program code are configured, with the at least one processor, to cause the apparatus at least to determine a transmission pattern for a user equipment operating in device to device communication, wherein the pattern is obtained from a dictionary of transmission patterns consisting of patterns of a combinatorial design in an ordered list such that a pattern representing a smallest integer from all patterns of the combinatorial design is provided first followed by all consecutive cyclic shifts of the pattern representing the smallest integer followed subsequently by next patterns representing a smallest integer from all patterns of the combinatorial design not already in the ordered list and their respective consecutive cyclic shifts.

According to a second aspect of the present invention there is disclosed a method comprising determining a transmission pattern for a user equipment operating in device to device communication, wherein the pattern is obtained from a dictionary of transmission patterns consisting of patterns of a combinatorial design in an ordered list such that a pattern representing a smallest integer from all patterns of the combinatorial design is provided first followed by all consecutive cyclic shifts of the pattern representing the smallest integer followed subsequently by next patterns representing a smallest integer from all patterns of the combinatorial design not already in the ordered list and their respective consecutive cyclic shifts.

According to a third aspect of the present invention there is disclosed a computer program, embodied on a non-transitory computer readable medium, wherein the computer program is configured to control a processor to perform a process, comprising determining a transmission pattern for a user equipment operating in device to device communication, wherein the pattern is obtained from a dictionary of transmission patterns consisting of patterns of a combinatorial design in an ordered list such that a pattern representing a smallest integer from all patterns of the combinatorial design is provided first followed by all consecutive cyclic shifts of the pattern representing the smallest integer followed subsequently by next patterns representing a smallest integer from all patterns of the combinatorial design not already in the ordered list and their respective consecutive cyclic shifts.

### BRIEF DESCRIPTION OF THE DRAWINGS

FIG. 1 illustrates a discovery pattern format that can be used in embodiments of the present invention;

FIG. 2 illustrates a discovery pattern of a type that can be generated using embodiments of the present invention;

FIG. 3 illustrates a discovery pattern and resource mapping of a type that can be performed using embodiments of the present invention;

FIG. 4 illustrates a network comprising a UE cluster that can implement discovery signaling according to embodiments of the present invention;

FIG. 5 illustrates hardware elements that can be used to carry out one or more embodiments of the present invention;

### DETAILED DESCRIPTION

Embodiments of the present invention solve various problems relating to signaling. Examples are presented here in terms of Type 2B discovery, but it will be recognized that embodiments of the present invention may be suitable in numerous other applications. For example, one or more embodiments of the present invention may be used to define time domain patterns and resource allocations generally, including for scheduling assignments needed in device to device data transmissions, for characterizing resource pools for Type 1 discovery, in the definition of Resource pattern of transmission (RPT) in D2D communications, or in numerous other applications.

Type 2B discovery employs a resource space that defines M parallel resources and N serial resources. The resource space may be defined for logical resources, but it is equally possible to directly define the space for physical resources. If the space is defined for logical resources, each logical resource may point be associated with particular physical resources, with the mapping between logical and physical resources being specified, or being computed or otherwise determined according to some mechanism. A physical discovery resource defined by the logical resource can be, for example, one, two, or three physical resource blocks in frequency and one subframe in time.

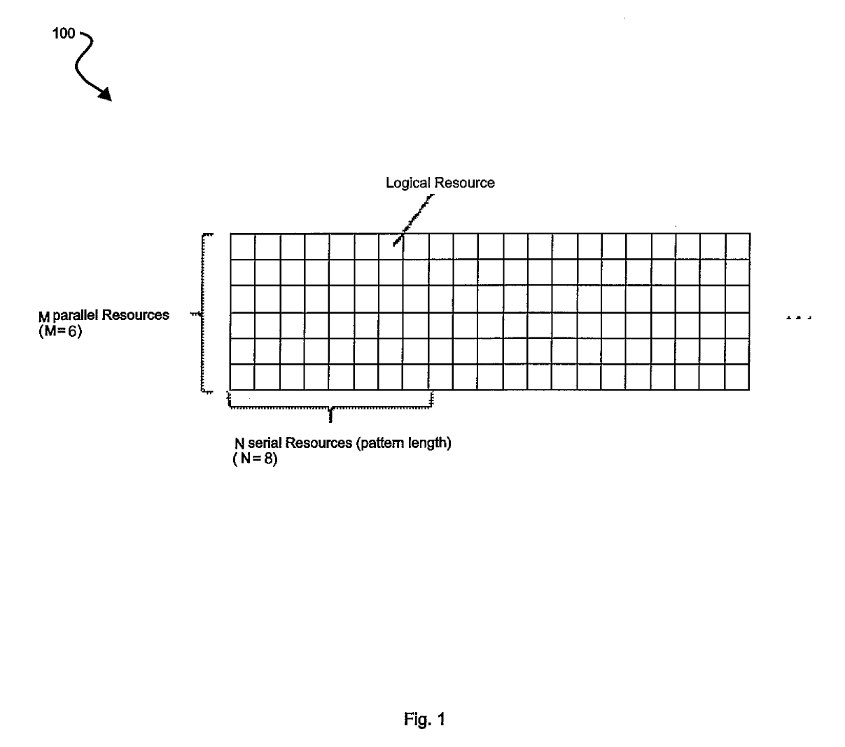

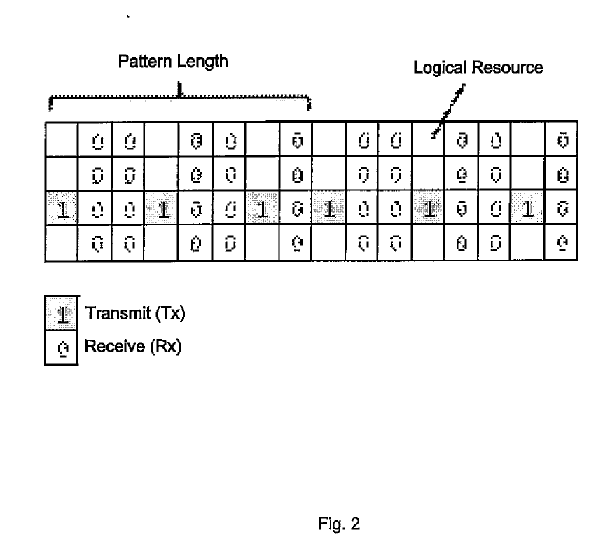

FIG. 1 illustrates a format 100 of logical discovery resources, and the logical discovery resources may be mapped to actual physical resources. In one example, use of discovery resources can be characterized by a discovery pattern of transmission, reception, and transmitting, receiving, and unused resources may be arranged in a discovery pattern. FIG. 2 illustrates a discovery pattern defining time intervals (such as subframes) in which a UE transmits a predefined discover signal on predefined resource. During time intervals during which the UE is not transmitting it will listen for discovery signals from other UEs, but when the UE is transmitting it cannot listen for other UEs' discovery signals. This limitation is referred to as a half duplex constraint.

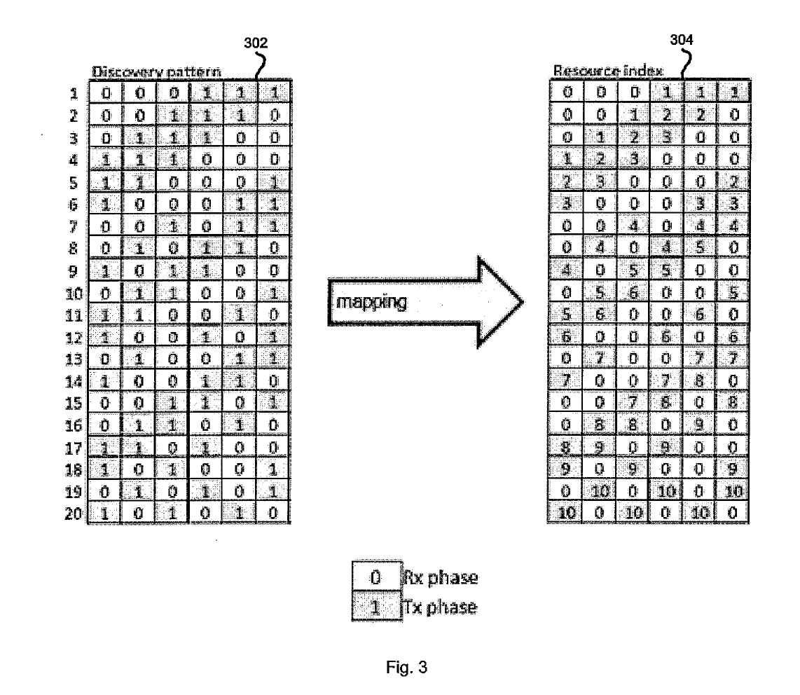

A discovery pattern may (as noted above) be defined in terms of logical resources, with logical resources being mapped to physical resources. To combine multiple copies of the same discovery message from another UE which are received on some physical resources, a UE also needs to establish the mapping from physical resources to logical resources (“backward mapping”), which requires the use of the inverse function of mapping from logical resources to physical resources (“forward mapping”). The mapping of logical resources to physical resources is one-to-one, and (as exemplified by the procedure given below) forward mapping is well defined. Therefore, it is easier to establish the association of physical resources to logical resources and in turn to a transmit pattern through forward mapping rather than backward mapping. In other words, if a UE enumerates all the allowed transmit patterns and their associated physical resources, the mapping between logical resources and physical resources is well defined. An example of mapping of a discovery pattern (comprising local resources) to a resource index pattern (pointing to physical resources) is presented in FIG. 3, which presents a discovery pattern 302 and a resource index pattern 304.

Various attempts to address pattern definition and mapping have been undertaken. For example, combinatorial designs and constant weight code designs have been proposed. Signal efficiency, complexity, and flexibility are always important considerations in wireless communication, given the ever-increasing demands for more and more data services. Embodiments of the present invention provide for flexible discovery approaches, pattern designs of reasonable complexity, and the ability to adjust characteristics of the discovery signaling—for example, balancing between various aspects of performance.

One or more embodiments of the invention provide for versatile approaches for defining and signaling discovery patterns and related resources for type 2B discovery.
1. The transmit patterns from a combinatorial design are classified according to starting transmit patterns; in a typical case a number of starting transmit patterns are defined.
2. The starting transmit patterns from a constant weight design are identified; these are preferred over other starting transmit patterns from which no or few constant weight design transmit patterns are derived;
3. transmit patterns from the combinatorial design are arranged as blocks of transposed Toeplitz matrices—that is, each row of the matrix is a cyclically shifted version of the related starting transmit pattern.
4. The constant weight property of each Toeplitz matrix is used to define mapping relationships between logical resources and physical resources.

One or more embodiments of the present invention provide mechanism to accommodate UEs having differing link budget requirements. For example, UEs at a cluster edge may be assigned transmit patterns which allow substantial numbers of receive opportunities between them and UEs at a cluster center may be assigned transmit patterns that allow fewer receive opportunities between them.

In one or more embodiments, the invention provides for a unified design rendering it unnecessary to specifically choose between (for example) combinatorial designs, constant weight code designs, and BCH code designs for transmit patterns. One example of a combinatorial pattern is a pattern design derived from the combinatorial design Comb(K_{c}, N). Comb(K_{c}, N) comprises of patterns choosing K_{c} positions out of N positions. Such a design allows at least one receive opportunity for two UEs to discover each other when they follow different patterns.

Transmit patterns based on a constant weight code C with weight W have a “constant weight” W by definition, and they belong to the subset of Comb(W,N): that is, the constant weight code C is a subset of Comb(W,N). A codeword in a code may be treated as a vector taking a value of either 0 or 1. The weight of a codeword is the number of 1's in the codeword. From this, it can be seen that transmit patterns from C provide more than one receive opportunity among one another. It is also guaranteed that a pattern selected from C and a pattern from selected from Comb(W, N)/C (it will be noted that Comb(W, N)/C is the set difference between Comb(W,N) and C) provide at least one receive opportunity for each other.

A useful way to categorize patterns from C and Comb(W,N)/C is through a cyclic shift described in greater detail below. The cyclic shift representation provides a discovery resource configuration that is easily adaptable to future developments and provide different levels of protection to UEs (in terms of receive opportunities). The choice of the transmit patterns is made at a low level so all imaginable patterns can be supported. This feature helps to insure that the signalling principles and solutions are maximally available for re-use—for example, when new patterns and/or functionalities are introduced into any communication or other system that may benefit from the use of these principles, notably including, but not limited to, new LTE releases. Furthermore, the low-level choice of transmit patterns with the associated unlimited or nearly unlimited support of transmit patterns allows combination of different discovery principles into a single signalling framework.

Specifically, in order to meet different coverage requirements: D2D UEs at coverage perimeters are assigned transmit patterns from C, and D2D UEs at coverage center are assigned transmit patterns from Comb (W, N)/C.

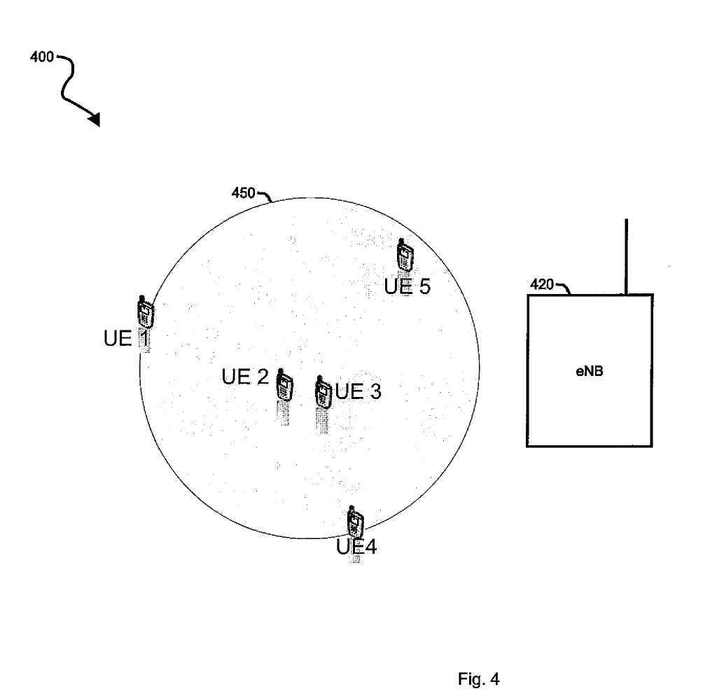

FIG. 4 illustrates wireless network 400 comprising an eNB 420 and a UE cluster 450, with UEs 2 and UE 3 at the cluster center; and UEs 1, 4, and 5 at the cluster edge. It is more challenging for UE 1 to discover UE 4 than for UE 2 to discover UE 3 or UE 1. Thus, the links between UE 1 and UE 4 need to be more robust than the links between UE 1 and (for example) UE 2. In other words, it is more difficult for the cluster edge UEs 1, 4, and 5 to discover each other than it is for the cluster center UEs 2 and 3 to detect other UEs.

In general, the constant weight code is not necessarily cyclic. Once this is taken into account, it can be understood that the transmit patterns derived from a single starting transmit pattern do not all belong to C. Considerable computational effort is thus required to choose the starting transmit patterns.

It will first be observed that there is one-to-one mapping between a transmit pattern, and the binary representation of an integer and a polynomial:

A transmit pattern can be represented by
a vector [h₀ h₁ . . . h_{N-1}], where h₀, . . . , h_{N-1} takes a value from {0,1}.
an integer

$${\sum }_{n = 0}^{N - 1} {h}_{n} {2}^{n}$$

or
a polynomial

$${\sum }_{n = 0}^{N - 1} {h}_{n} {x}^{n} .$$

The cyclic shift of the transmit pattern towards the right is equivalent to the representation given below:
a vector [h_{N-1} h₀ h₁ . . . h_{N-2}], or

$$( 2 \times ( {\sum }_{n = 0}^{N - 1} {h}_{n} {2}^{n} ) ) mod ( {2}^{N} - 1 ) , or ( x \times ( {\sum }_{n = 0}^{N - 1} {h}_{n} {x}^{n} ) ) mod ( {x}^{N} - 1 ) .$$

It can thus be seen that a vector, an integer, or a polynomial can be used interchangeably to represent a transmit pattern; and a transmit pattern can be treated as being generated from cyclically shifting a starting transmit pattern which has the property that h₀≠0; many different transmit patterns can be generated from one starting transmit pattern. This introduction of the definition of a starting transmit pattern and its cyclic shifts can greatly simplify the definition of transmit patterns from Comb(K_{c}, N). Details of identification of starting Tx patterns (transmit patterns) and relevant parameters concerning these starting transmit patterns are discussed below. Discussed below is the construction of a “master dictionary” from a combinatorial design, followed by discussion of preferred starting transmit patterns from a constant weight code. The transmit patterns derived by cyclically shifting one starting transmit pattern are also referred to as subcodes derived from the starting transmit pattern in the following discussion.

### Construction of the Master Dictionary

Let the set of all the integers corresponding to the Tx patterns generated by a combinatorial design Comb(K_{c}, N) be B.
1. Start with D=B, Dictionary={ } and i=0
2. If D is empty, let I=i and go to step 4; otherwise pick the smallest integer a in D, let i=i+1 and pᵢ=a.
3. Calculate the N cyclic shifts (2⁰ a)mod(2^{N}−1), (2¹ a)mod(2^{N}−1), . . . , (2^{N-1} a)mod(2^{N}−1), and find elements in D taking the same values as them; let their number be N_{cyc,i}; remove those elements from D; Dictionary←Dictionary ∪{(pᵢ,N_{cyc,i})}. Go to step 2.

4. Let the master dictionary be {(pᵢ, n_{cyc,i}),i=1, 2, . . . , I}.

It is noted that steps 2 and 3 should be recursively run until the procedure is ended in step 4.

### Identifying Preferred Starting Tx Patterns

Let the Tx patterns generated by a constant weight code (e.g. the Steiner Triple System or Steiner Quadruple System) be B′, scan B′ with the following procedure
1. Start with D=B′ and i=0
2. If D is empty, let I=i and go to step 4, otherwise let i=i+1, a=pᵢ.
3. Calculate (2⁰ a)mod(2^{N}−1), (2¹ a)mod(2^{N}−1), . . . , (2^{N-1}a)mod(2^{N}−1), and find elements in D take the same values as them; let their number be Ñ_{cyc,i}; remove those elements from D;
4. Ñ_{cyc,i}, i=1, 2, . . . , I gives the hits of pᵢ's cyclic shifts in B′.

It is noted that steps 2 and 3 should be recursively run until the procedure is ended in step 4.

### Logical to Physical Mapping

For example, consider Comb(K_{c}=2, N=12). Using the procedure discussed above, six starting transmit patterns are obtained:
1. p₁=[1 1 0 0 0 0 0 0 0 0 0 0]
2. p₂=[1 0 1 0 0 0 0 0 0 0 0 0]
3. p₃=[1 0 0 1 0 0 0 0 0 0 0 0]
4. p₄=[1 0 0 0 1 0 0 0 0 0 0 0]
5. P₅=[1 0 0 0 0 1 0 0 0 0 0 0]
6. P₆=[1 0 0 0 0 0 1 0 0 0 0 0]

All the transmit patterns from Comb(K_{c}=2, N=12) can be generated from cyclically shifting pᵢ by 12 times for i=1,2,3,4,5; and by 6 times for i=6 (if p₆ is cyclically shifted by 12 times, then there are only 6 unique patterns among them. In another word, the transmit patterns/codewords from Comb(K_{c}=2, N=12) are derived from 6 cyclic sub-codes generated from pᵢ with i=1,2,3,4,5,6.

Some of the Tx patterns from Comb(K_{c}=2, N=12), corresponding to the starting Tx patterns pᵢ, i=1,2,3, are given below for reference (while all of the patterns corresponding to p₁ and p₂ are shown, only part of the patterns corresponding to the third starting transmit pattern p₃ is shown):

$$[ \begin{matrix}1 & 1 & 0 & 0 & 0 & 0 & 0 & 0 & 0 & 0 & 0 & 0 \\ 0 & 1 & 1 & 0 & 0 & 0 & 0 & 0 & 0 & 0 & 0 & 0 \\ 0 & 0 & 1 & 1 & 0 & 0 & 0 & 0 & 0 & 0 & 0 & 0 \\ 0 & 0 & 0 & 1 & 1 & 0 & 0 & 0 & 0 & 0 & 0 & 0 \\ 0 & 0 & 0 & 0 & 1 & 1 & 0 & 0 & 0 & 0 & 0 & 0 \\ 0 & 0 & 0 & 0 & 0 & 1 & 1 & 0 & 0 & 0 & 0 & 0 \\ 0 & 0 & 0 & 0 & 0 & 0 & 1 & 1 & 0 & 0 & 0 & 0 \\ 0 & 0 & 0 & 0 & 0 & 0 & 0 & 1 & 1 & 0 & 0 & 0 \\ 0 & 0 & 0 & 0 & 0 & 0 & 0 & 0 & 1 & 1 & 0 & 0 \\ 0 & 0 & 0 & 0 & 0 & 0 & 0 & 0 & 0 & 1 & 1 & 0 \\ 0 & 0 & 0 & 0 & 0 & 0 & 0 & 0 & 0 & 0 & 1 & 1 \\ 1 & 0 & 0 & 0 & 0 & 0 & 0 & 0 & 0 & 0 & 0 & 1 \\ 1 & 0 & 1 & 0 & 0 & 0 & 0 & 0 & 0 & 0 & 0 & 0 \\ 0 & 1 & 0 & 1 & 0 & 0 & 0 & 0 & 0 & 0 & 0 & 0 \\ 0 & 0 & 1 & 0 & 1 & 0 & 0 & 0 & 0 & 0 & 0 & 0 \\ 0 & 0 & 0 & 1 & 0 & 1 & 0 & 0 & 0 & 0 & 0 & 0 \\ 0 & 0 & 0 & 0 & 1 & 0 & 1 & 0 & 0 & 0 & 0 & 0 \\ 0 & 0 & 0 & 0 & 0 & 1 & 0 & 1 & 0 & 0 & 0 & 0 \\ 0 & 0 & 0 & 0 & 0 & 0 & 1 & 0 & 1 & 0 & 0 & 0 \\ 0 & 0 & 0 & 0 & 0 & 0 & 0 & 1 & 0 & 1 & 0 & 0 \\ 0 & 0 & 0 & 0 & 0 & 0 & 0 & 0 & 1 & 0 & 1 & 0 \\ 0 & 0 & 0 & 0 & 0 & 0 & 0 & 0 & 0 & 1 & 0 & 1 \\ 1 & 0 & 0 & 0 & 0 & 0 & 0 & 0 & 0 & 0 & 1 & 0 \\ 0 & 1 & 0 & 0 & 0 & 0 & 0 & 0 & 0 & 0 & 0 & 1 \\ 1 & 0 & 0 & 1 & 0 & 0 & 0 & 0 & 0 & 0 & 0 & 0 \\ 0 & 1 & 0 & 0 & 1 & 0 & 0 & 0 & 0 & 0 & 0 & 0 \\ 0 & 0 & 1 & 0 & 0 & 1 & 0 & 0 & 0 & 0 & 0 & 0 \\ 0 & 0 & 0 & 1 & 0 & 0 & 1 & 0 & 0 & 0 & 0 & 0 \\ 0 & 0 & 0 & 0 & 1 & 0 & 0 & 1 & 0 & 0 & 0 & 0 \\ 0 & 0 & 0 & 0 & 0 & 1 & 0 & 0 & 1 & 0 & 0 & 0 \\ 0 & 0 & 0 & 0 & 0 & 0 & 1 & 0 & 0 & 1 & 0 & 0\end{matrix} ]$$

Using p₁ to illustrate the pattern generation, and noting that the weight of p₁ is 2, it is easy to see the Tx patterns derived from p₁ consume two parallel resources:

$$[ \begin{matrix}1 & 1 & 0 & 0 & 0 & 0 & 0 & 0 & 0 & 0 & 0 & 0 \\ 0 & 1 & 1 & 0 & 0 & 0 & 0 & 0 & 0 & 0 & 0 & 0 \\ 0 & 0 & 1 & 1 & 0 & 0 & 0 & 0 & 0 & 0 & 0 & 0 \\ 0 & 0 & 0 & 1 & 1 & 0 & 0 & 0 & 0 & 0 & 0 & 0 \\ 0 & 0 & 0 & 0 & 1 & 1 & 0 & 0 & 0 & 0 & 0 & 0 \\ 0 & 0 & 0 & 0 & 0 & 1 & 1 & 0 & 0 & 0 & 0 & 0 \\ 0 & 0 & 0 & 0 & 0 & 0 & 1 & 1 & 0 & 0 & 0 & 0 \\ 0 & 0 & 0 & 0 & 0 & 0 & 0 & 1 & 1 & 0 & 0 & 0 \\ 0 & 0 & 0 & 0 & 0 & 0 & 0 & 0 & 1 & 1 & 0 & 0 \\ 0 & 0 & 0 & 0 & 0 & 0 & 0 & 0 & 0 & 1 & 1 & 0 \\ 0 & 0 & 0 & 0 & 0 & 0 & 0 & 0 & 0 & 0 & 1 & 1 \\ 1 & 0 & 0 & 0 & 0 & 0 & 0 & 0 & 0 & 0 & 0 & 1\end{matrix} ]$$

It will be recognized that the above matrix is actually the transpose of the circulant Toeplitz matrix

$$T ( h ) = [ \begin{matrix}{h}_{0} & {h}_{N - 1} & … & {h}_{2} & {h}_{1} \\ {h}_{1} & {h}_{0} & {h}_{N - 1} & & \\ ⋮ & {h}_{1} & {h}_{0} & ⋱ & ⋮ \\ {h}_{N - 2} & & ⋱ & ⋱ & {h}_{N - 1} \\ {h}_{N - 1} & {h}_{N - 2} & … & {h}_{1} & {h}_{0}\end{matrix} ]$$

$$with h = {p}_{1} : \\ [ \begin{matrix}{h}_{0} & {h}_{1} & ⋮ & {h}_{N - 2} & {h}_{N - 1} \\ {h}_{N - 1} & {h}_{0} & {h}_{1} & & {h}_{N - 2} \\ … & {h}_{N - 1} & {h}_{0} & ⋱ & … \\ {h}_{2} & & ⋱ & ⋱ & {h}_{1} \\ {h}_{1} & & ⋮ & {h}_{N - 1} & {h}_{0}\end{matrix} ]$$

The Tx pattern for a UE is defined by an index i for pᵢ and the cyclic shift s taken to generate it. A UE can be signalled with information from eNB: for example a pattern index, from which an index i for pᵢ and the cyclic shift s can be derived; or alternatively an index i for pᵢ, with the cyclic shift s being signalled to the UE explicitly. The mapping, then, between the logical resource and the physical resource can be found in two steps:
1. The number of parallel resources occupied by subcodes (derived from a starting Tx pattern) from one of the preceding starting Tx patterns is a constant, for p₁, . . . , pₖ, k<i, and these will occupy a fixed amount of parallel resources before the patterns derived from pᵢ. In the example, for pᵢ,i=1,2,3,4,5, the constant is 2; for p₆, the constant is 1.
2. pᵢ and s are used to find the serial resource (n) at which the transmit opportunities are to be expected. n can be identified from “1”'s postions in the the binary representation of (2^{s-1}×pᵢ)mod(2^{N}−1) or the cyclic shift of pᵢ by (s−1) times. When s is 1, the resulting Tx pattern is simply pᵢ, that is, no cyclic shift is applied. The circulant Toeplitiz matrix defined by pᵢ is used to determine which (parallel) transmit opportunity (m) at serial resource n is available for the UE of interest:

$$m = [ \underbrace{\begin{matrix}1 & … & 1\end{matrix}}_{s {1}^{′} s} \underbrace{\begin{matrix}0 & … & 0\end{matrix}}_{( N - s ) {0}^{′} s} ] {T}^{T} ( {p}_{i} ) {e}_{n}$$

where T^{T}(pᵢ) is the transpose of T(pᵢ), eₙ is a N×1 vector with zeros for all elements except taking 1 at element n (counting from 1); or

$$m = {\sum }_{q = 1}^{s} {\overline{p}}_{i} ( N - ( q - 1 ) + ( n - 1 ) ) ,$$

where p̅ᵢ(x) is a cyclic extension of pᵢ(x) and pᵢ(0) is the first element of starting Tx pattern pᵢ, and pᵢ(N−1) is the last element of starting Tx pattern pᵢ.

For example, given a pattern index 16, we have i=2 (p₁ generates the first 12 subcodes, p₂ generates the second 12 subcodes), and 16 is between 13 and 24), s=16−12=4 (12 is for the subcodes or Tx patterns derived from p₁). Thus, the UE has transmit opportunities at serial resources 4 and 6 (taken from cyclically shifting p₂ by 3 times ((s−1) times): [0 0 0 1 0 1 0 0 0 0 0 0]). There are two parallel resources occupied by subcodes from p₁. The only step that remains is to find the location of the transmit opportunities for subcodes from p₂.

At serial resource 4, N−((1:4)−1)+(4−1)mod 12=[3 2 1 0] and p₂ (3)+p₂ (2)+p₂ (1)+p₂ (0)=2; so the parallel resource index occupied by the UE's transmit opportunity is 2+2 (the first 2 are due to parallel resources occupied by subcodes from p₁ and the third parallel resource is taken by the 14^{th} Tx pattern);

At serial resource 6, it can be understood from the equation below:

$${\sum }_{q = 1}^{4} {\overline{p}}_{2} ( N - ( q - 1 ) + ( 6 - 1 ) ) = {p}_{2} ( 5 ) + {p}_{2} ( 4 ) + {p}_{2} ( 3 ) + {p}_{2} ( 2 ) = 1$$

that the parallel resource index occupied by the UE's transmit opportunity at serial resource 6 is 2+1 (2 is due to parallel resources occupied by subcodes from p₁).

Assuming the dictionary consists of Tx patterns generated from 1≦i≦I starting Tx patterns, then to define a Tx pattern j generated from one starting Tx pattern, the following parameters are used:
N is the number of serial resources
pᵢ is an integer which specifies the starting Tx pattern
N_{step,i} is the cyclic shift step
N_{cyc,i} is the number of cyclic shifts allowed for the starting Tx pattern pᵢ
sⱼ is the cyclic shift index for Tx pattern j
N_{init,i} is the initial cyclic shift index

Then the integer corresponding to Tx pattern j is given by

(2^{N}^{_{init,i}}^{+(s}^{ⱼ}^{-1)N}^{_{step,i}}pᵢ)mod(2^{N}−1) (1)

In the example above, N_{init,i}=0, N_{step,i}=1, for i=1,2,3,4,5,6, and N_{cyc,i}=12, for i=1,2,3,4,5, and N_{cyc,6}=6.

Particular points of interest relating to the use of N_{init,i} and N_{step,i} are as follows:
One notable benefit of introducing N_{init,i} is to allow locating resources so they can be offset to other resources. For example, the Tx patterns are defined over 12 subframes as in the example above, if the availiablity of resources at subframes is not the same, for example the first 2 subframes have fewer resources available than the rest subframes, then N_{init,i}=2 can be used to offset the discovery resources and eNB refrains from assigning a pattern index which would require a UE to transmit/receive during the first two subframes.
A notable benefit of introducing N_{step,i} (for example N_{step,i}=2) is to allow the design given in the figure below to occupy just 1 parallel resource when the first 3 Tx patterns are configured in the system. Note that the second Tx pattern [001100] can be generated by cyclically shifting the first Tx pattern [110000] by 2; and the third Tx pattern [000011] can be generated by cyclically shifting the first Tx pattern [110000] by 4.

kc = 2, N = 6

| | | | | | |
|---|---|---|---|---|---|
| 1 | 1 | 0 | 0 | 0 | 0 |
| 0 | 0 | 1 | 1 | 0 | 0 |
| 0 | 0 | 0 | 0 | 1 | 1 |
| 0 | 1 | 1 | 0 | 0 | 0 |
| 0 | 0 | 0 | 1 | 1 | 0 |
| 1 | 0 | 0 | 0 | 0 | 1 |

The following information may be signalled (for example, in a system information block or a radio resource control message) concerning the discovery resource pool:
The number of starting transmit patterns
N the number of serial resources
for each starting transmit pattern: (pᵢ, N_{step,i}, N_{cyc,i}, N_{init,i}). Different cells may have the same parameter set to allow commonality among cells in order to provide smooth support inter-cell discovery, or different parameter sets to randomize collisions of discovery messages among different cells. It is also possible for some starting transmit patterns, the parameter set is common among cells while for other starting transmit patterns the parameter sets are different among cells so a tradeoff between support for inter-cell discovery and randomizating collisions is achieved.
The gap in parallel resource pool. In other words, some resource blocks in a subframe may not be available for the discovery pool in one cell.
   For an individual UE, the following or a pattern index is signalled:
The starting transmit pattern index k (i.e. the starting transmit pattern pₖ that is used to generate the UE's transmit pattern)
The cyclic shift index sⱼ
The pattern index can be used to derive the above two indices as shown in the example.

From the discussion above, it can be seen that the parallel resources occupied by the Tx patterns generated from a starting Tx pattern are the same across serial resources, and that the mapping between a logical index to the physical index can be executed in two steps. It can also be seen that there is a one-to-one mapping between the logical index and (k, sⱼ). From equation 1, with the information on the discovery resource pool and (k, sⱼ), the logical and physical resources taken by a UE is fully determined.

The eNB then has the responsibility for configuring the discovery resource pool and assigning a logical index to a UE. There are many ways to specify the starting Tx pattern pᵢ and related parameters, so that the desired protection is achieved for a UE.

A specific example of creation and mapping of a discovery pattern according to an embodiment of the present invention is presented below. A master dictionary, developed using the combinatorial design Comb(K_{c}=3, N=30), is:

{ (7,30),(11,30),(13,30),(19,30),(21,30),(25,30),(35,30),(37,30),(41,30),(49,30),
(67,30),(69,30),(73,30),(81,30),(97,30),(131,30),(133,30),(137,30),(145,30),(161,30),
(193,30),(259,30),(261,30),(265,30),(273,30),(289,30),(321,30),(385,30),(515,30),
(517,30),(521,30),(529,30),(545,30),(577,30),(641,30),(769,30),(1027,30),(1029,30),
(1033,30),(1041,30),(1057,30),(1089,30),(1153,30),(1281,30),(1537,30),(2051,30),
(2053,30),(2057,30),(2065,30),(2081,30),(2113,30),(2177,30),(2305,30),(2561,30),
(3073,30),(4099,30),(4101,30),(4105,30),(4113,30),(4129,30),(4161,30),(4225,30),
(4353,30),(4609,30),(5121,30),(6145,30),(8195,30),(8197,30),(8201,30),(8209,30),
(8225,30),(8257,30),(8321,30),(8449,30),(8705,30),(9217,30),(10241,30),(12289,30),
(16387,30),(16389,30),(16393,30),(16401,30),(16417,30),(16449,30),(16513,30),
(16641,30),(16897,30),(17409,30),(18433,30),(20481,30),(24577,30),(32771,30),
(32773,30),(32777,30),(32785,30),(32801,30),(32833,30),(32897,30),(33025,30),
(33281,30),(33793,30),(34817,30),(36865,30),(40961,30),(49153,30),(65541,30),
(65545,30),(65553,30),(65569,30),(65601,30),(65665,30),(65793,30),(66049,30),
(66561,30),(67585,30),(69633,30),(73729,30),(131089,30),(131105,30),(131137,30),
(131201,30),(131329,30),(131585,30),(132097,30),(133121,30),(135169,30),
(262209,30),(262273,30),(262401,30),(262657,30),(263169,30),(264193,30),
(524545,30),(524801,30),(525313,30),(1049601,10)}.

Each entry is of the form form (pᵢ,n_{cyc,i}). The hit list at N=30 (for the Steiner Triple System (STS)) is: 69/12, 145/9, 321/6, 769/3, 1027/12, 2057/9, 2053/12, 4129/6, 4113/9, 8321/3, 8257/6, 16641/3, 32771/15, 65545/12, 131105/9, 262273/6, 524801/3, 1049601/5.

Each entry takes the format pᵢ/Ñ_{cyc,i} (the starting Tx pattern as an integer)/(number of unique shifts)). With pᵢ=69, 30 unique cyclic shifts can be generated from Comb (K_{c}=3, N=30). Among these are 12 unique cyclic shifts included in the Tx patterns generated by the STS at N=30. The rest of the hit list can be understood similarly.

In a SIB (System Information Block) message, a RRC (Radio Resource Control) signaling or a broadcasted control message, the following may be included:

$$[ \begin{matrix}{p}_{i} & {N}_{step , i} & {N}_{cyc , i} & {N}_{init , i} \\ 69 & 1 & 30 & 0 \\ 145 & 1 & 30 & 0 \\ 321 & 1 & 30 & 0 \\ 769 & 1 & 30 & 0 \\ 1027 & 1 & 30 & 0 \\ 2053 & 1 & 30 & 0 \\ 2057 & 1 & 30 & 0 \\ 4113 & 1 & 30 & 0 \\ 4129 & 1 & 30 & 0 \\ 8257 & 1 & 30 & 0 \\ 8321 & 1 & 30 & 0 \\ 16641 & 1 & 30 & 0 \\ 32771 & 1 & 30 & 0 \\ 65545 & 1 & 30 & 0 \\ 131105 & 1 & 30 & 0 \\ 262273 & 1 & 30 & 0 \\ 524801 & 1 & 30 & 0 \\ 1049601 & 1 & 10 & 0\end{matrix} ]$$

Thus, there are 520 Tx patterns for which it is guaranteed that there is at least one Rx opportunity for any UE targeting another UE.

In addition, there are 140 Tx patterns for which it is guaranteed that there are at least 2 receive opportunities for any UE targeting another UE if these UEs are assigned Tx patterns from those 140 Tx patterns. Hence, 140 patterns from STS can be used for cluster edge UEs, and the rest of the Tx patterns may be used used for cluster center UEs.

It is noted in the example above, only the starting Tx patterns from which at least one codeword in a constant weight code can be generated are included. It is also possible to include additional starting Tx patterns such as pᵢ=7 and pᵢ=11 in the SIB or RRC signaling to support more UEs. It will be noted that the Tx patterns generated from pᵢ=7 and pᵢ=11 guarantee at least one Rx opportunity.

Depending on the discovery load situation in a system, it is also possible that instead of including in the SIB or RRC signaling all the starting Tx patterns from which at least one codeword in a constant weight code can be generated, it may be desired to include only some starting Tx patterns from which at least one codeword in a constant weight code can be generated. One selection criterion of the starting Tx patterns can be the ratio of generated codewords in the constant weight code among all generated codewords. For example, for pᵢ=32771 the ratio is 15/30, for p=1049601, the ratio is 5/10, for pᵢ=69, the ratio is 12/30, for pᵢ=769, the ratio is 3/30. It is seen that pᵢ=32771 is preferred over pᵢ=69; in turn pᵢ=69 is preferred over pᵢ=769. One example to illustrate the selection principle is given below:

$$[ \begin{matrix}{p}_{i} & {N}_{step , i} & {N}_{cyc , i} & {N}_{init , i} \\ 69 & 1 & 30 & 0 \\ 32771 & 1 & 30 & 0 \\ 1049601 & 1 & 10 & 0\end{matrix} ]$$

It is noted that by selecting pᵢ and its related parameters wisely, the benefit with the Steiner Triple system can be enjoyed with little effort: no modification on the eNB and UE is necessary once the general signaling framework is supported. Replacing the Steiner Triple system with other constructions from Coding theory, Design theory and other branches of discrete mathematics, then developments in discrete mathematics which provide a new or better Tx pattern design can be readily applied in the D2D discovery without a requirement to modify specifications. The useful starting Tx patterns from a new construction can be identified with the procedure of identifying the preferred starting Tx patterns for a constant weight code. By using different numbers of preferred starting Tx patterns and other starting Tx patterns, the network provides the support for different load situations considering the number of cluster edge UEs and cluster center UEs. For example, when the number of UEs engaged in discovery is small, only a few starting Tx patterns in total are configured or signaled by the network; when there are many UE engaged in discovery, then more starting Tx patterns are configured or signaled. Similar adjustments on the number of preferred starting Tx patterns and the number of non-preferred starting Tx patterns can be also applied according to the number of cluster edge UEs and the number of cluster center UEs. Hence the disclosed signaling method provides a future-proof and ever evolving support for D2D discovery.

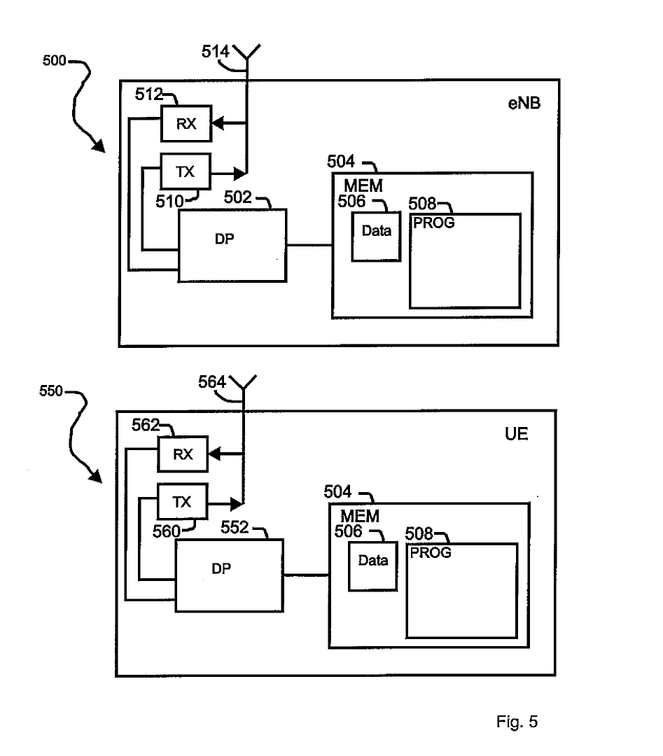

FIG. 5 illustrates details of an eNB (eNB) 500, and a user equipment (UE) 550. The eNB 500 may suitably comprise a transmitter 502, receiver 504, and antenna 506. The eNB 500 may also include a processor 508 and memory 510. The eNB 500 may employ data 512 and programs (PROGS) 514, residing in memory 510.

The UE 550 may suitably comprise a transmitter 552, receiver 554, and antenna 556. The UE 550 may also include a processor 558 and memory 560. The UE 550 may employ data 562 and programs (PROGS) 564, residing in memory 560.

At least one of the PROGs 514 in the eNB 500 is assumed to include a set of program instructions that, when executed by the associated DP 508, enable the device to operate in accordance with the exemplary embodiments of this invention, as detailed above. In these regards the exemplary embodiments of this invention may be implemented at least in part by computer software stored on the MEM 510, which is executable by the DP 508 of the eNB 500, or by hardware, or by a combination of tangibly stored software and hardware (and tangibly stored firmware). Similarly, at least one of the PROGs 564 in the UE 550 is assumed to include a set of program instructions that, when executed by the associated DP 558, enable the device to operate in accordance with the exemplary embodiments of this invention, as detailed above. In these regards the exemplary embodiments of this invention may be implemented at least in part by computer software stored on the MEM 560, which is executable by the DP 558 of the UE 550, or by hardware, or by a combination of tangibly stored software and hardware (and tangibly stored firmware). Electronic devices implementing these aspects of the invention need not be the entire devices as depicted at FIG. 4 or FIG. 5 or may be one or more components of same such as the above described tangibly stored software, hardware, firmware and DP, or a system on a chip SOC or an application specific integrated circuit ASIC.

In general, the various embodiments of the UE 550 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEM 510 and 560 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DP 508 and 558 include but are not limited to general purpose computers, special purpose computers, microprocessors, digital signal processors (DSPs) and multi-core processors.

In one embodiment of the invention, a method comprises determining discovery patterns for a plurality of UEs operating in device to device communication, wherein determining discovery patterns for UEs comprises computing the discovery pattern based on a starting transmit pattern.

In another embodiment of the invention, discovery patterns are determined for UEs such that the receive opportunities for a UE is based at least in part on whether network conditions make it easier or more difficult to detect other UEs.

In another embodiment of the invention, discovery patterns are determined such that the number of receive opportunities for a UE is determined based on whether the UE is near the center or an edge of a UE cluster.

In another embodiment of the invention, discovery patterns are determined such that UEs near the edge of a UE cluster have more receive opportunities and UEs near the center of a UE cluster have fewer receive opportunities.

In another embodiment of the invention, starting transmit patterns are preferred which yield a relatively large number of constant weight design discovery patterns.

In another embodiment of the invention, combinatorial design transmit patterns are arranged as blocks of transposed Toeplitz matrices.

In another embodiment of the invention, mapping relationships between logical and physical resources are based at least in part on constant weight properties of the Toeplitz matrices.

In another embodiment of the invention, the discovery pattern for a UE is defined by an index and a cyclic shift taken to generate the discovery pattern.

In another embodiment of the invention, the available starting transmit patterns and legal cyclic shift step values are predefined.

In another embodiment of the invention, a discovery pattern generated from a starting transmit pattern is based on parameters including the number of serial resources, an integer specifying the starting transmit pattern, the cyclic shift step, the number of cyclic shifts allowed for the starting transmit pattern, the cyclic shift index for the discovery pattern, and the initial cyclic shift index.

In another embodiment of the invention, parameters relating to generation of a discovery pattern are conveyed in a system information block message or a radio resource control message.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description. It will be further recognized that the various blocks illustrated in FIG. 6 and discussed above may be performed as steps, but the order in which they are presented is not limiting and they may be performed in any appropriate order with or without additional intervening blocks or steps.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

We claim:

1. A method comprising:
determining a transmission pattern for a user equipment operating in device to device communication, wherein the transmission pattern is obtained from a dictionary of transmission patterns consisting of patterns of a combinatorial design in an ordered list such that a pattern representing a smallest integer from all patterns of the combinatorial design is provided first followed by all consecutive cyclic shifts of the pattern representing the smallest integer followed subsequently by next patterns representing a smallest integer from all patterns of the combinatorial design not already in the ordered list and their respective consecutive cyclic shifts.

2. The method of claim 1, wherein the patterns of the combinatorial design consist of patterns of length 12 and constant weight 2.

3. The method of claim 2, wherein the pattern representing a smallest integer from all patterns of the combinatorial design and next patterns representing a smallest integer from all patterns of the combinatorial design not already in the ordered list are sequentially provided by rows of the matrix
$$[ \begin{matrix}1 & 1 & 0 & 0 & 0 & 0 & 0 & 0 & 0 & 0 & 0 & 0 \\ 1 & 0 & 1 & 0 & 0 & 0 & 0 & 0 & 0 & 0 & 0 & 0 \\ 1 & 0 & 0 & 1 & 0 & 0 & 0 & 0 & 0 & 0 & 0 & 0 \\ 1 & 0 & 0 & 0 & 1 & 0 & 0 & 0 & 0 & 0 & 0 & 0 \\ 1 & 0 & 0 & 0 & 0 & 1 & 0 & 0 & 0 & 0 & 0 & 0 \\ 1 & 0 & 0 & 0 & 0 & 0 & 1 & 0 & 0 & 0 & 0 & 0\end{matrix} ] .$$

4. The method of claim 3, wherein the dictionary comprises 12 consecutive cyclic shifts for each of the first 5 rows of the matrix and 6 consecutive cyclic shifts for the last row of the matrix.

5. The method of claim 1, further comprising transmitting a device-to-device discovery signal on subframe resources selected in accordance with the determined transmission pattern.

6. The method of claim 1, wherein the determined transmission pattern is selected from the dictionary in accordance with at least one pattern index obtained from an assignment by a base station.

7. The method of claim 1, further comprising
forming a subset of transmission patterns in the dictionary such that a number of reception opportunities for any pair of patterns selected from the subset is larger than a number of reception opportunities between a pattern from the subset and a pattern outside the subset.

8. The method of claim 7, wherein determining the transmission pattern comprises determining whether the transmission pattern is to be selected from the subset at least in part based on at least one of a user equipment detection condition and a location of a user equipment relative to the center or edge of a user equipment cluster.

9. An apparatus, comprising:
at least one processor; and
at least one memory including computer program code,
wherein the at least one memory and the computer program code are configured, with the at least one processor, to cause the apparatus at least to
determine a transmission pattern for a user equipment operating in device to device communication, wherein the transmission pattern is obtained from a dictionary of transmission patterns consisting of patterns of a combinatorial design in an ordered list such that a pattern representing a smallest integer from all patterns of the combinatorial design is provided first followed by all consecutive cyclic shifts of the pattern representing the smallest integer followed subsequently by next patterns representing a smallest integer from all patterns of the combinatorial design not already in the ordered list and their respective consecutive cyclic shifts.

10. The apparatus of claim 9, wherein the patterns of the combinatorial design consist of patterns of length 12 and constant weight 2.

11. The apparatus of claim 10, wherein the pattern representing a smallest integer from all patterns of the combinatorial design and next patterns representing a smallest integer from all patterns of the combinatorial design not already in the ordered list are sequentially provided by rows of the matrix
$$[ \begin{matrix}1 & 1 & 0 & 0 & 0 & 0 & 0 & 0 & 0 & 0 & 0 & 0 \\ 1 & 0 & 1 & 0 & 0 & 0 & 0 & 0 & 0 & 0 & 0 & 0 \\ 1 & 0 & 0 & 1 & 0 & 0 & 0 & 0 & 0 & 0 & 0 & 0 \\ 1 & 0 & 0 & 0 & 1 & 0 & 0 & 0 & 0 & 0 & 0 & 0 \\ 1 & 0 & 0 & 0 & 0 & 1 & 0 & 0 & 0 & 0 & 0 & 0 \\ 1 & 0 & 0 & 0 & 0 & 0 & 1 & 0 & 0 & 0 & 0 & 0\end{matrix} ] .$$

12. The apparatus of claim 11, wherein the dictionary comprises 12 consecutive cyclic shifts for each of the first 5 rows of the matrix and 6 consecutive cyclic shifts for the last row of the matrix.

13. The apparatus of claim 9, wherein the at least one memory and the computer program code are further configured, with the at least one processor, to transmit a device-to-device discovery signal on subframe resources selected in accordance with the determined transmission pattern.

14. The apparatus of claim 9, wherein the determined transmission pattern is selected from the dictionary in accordance with at least one pattern index obtained from an assignment by a base station.

15. The apparatus of claim 9, wherein the at least one memory and the computer program code are further configured, with the at least one processor, to determine a subset of transmission patterns in the dictionary such that a number of reception opportunities for any pair of patterns selected from the subset is larger than a number of reception opportunities between a pattern from the subset and a pattern outside the subset.

16. The apparatus of claim 15, wherein the at least one memory and the computer program code are further configured, with the at least one processor, to
determine whether the transmission pattern is to be selected from the subset at least in part based on at least one of a user equipment detection condition and a location of a user equipment relative to the center or edge of a user equipment cluster.

17. A computer program, embodied on a non-transitory computer readable medium, wherein the computer program is configured to control a processor to perform a process, comprising:
determining a transmission pattern for a user equipment operating in device to device communication, wherein the transmission pattern is obtained from a dictionary of transmission patterns consisting of patterns of a combinatorial design in an ordered list such that a pattern representing a smallest integer from all patterns of the combinatorial design is provided first followed by all consecutive cyclic shifts of the pattern representing the smallest integer followed subsequently by next patterns representing a smallest integer from all patterns of the combinatorial design not already in the ordered list and their respective consecutive cyclic shifts.

18. The computer program of claim 17, wherein the patterns of the combinatorial design consist of patterns of length 12 and constant weight 2 and wherein the pattern representing a smallest integer from all patterns of the combinatorial design and next patterns representing a smallest integer from all patterns of the combinatorial design not already in the ordered list are sequentially provided by rows of the matrix
$$[ \begin{matrix}1 & 1 & 0 & 0 & 0 & 0 & 0 & 0 & 0 & 0 & 0 & 0 \\ 1 & 0 & 1 & 0 & 0 & 0 & 0 & 0 & 0 & 0 & 0 & 0 \\ 1 & 0 & 0 & 1 & 0 & 0 & 0 & 0 & 0 & 0 & 0 & 0 \\ 1 & 0 & 0 & 0 & 1 & 0 & 0 & 0 & 0 & 0 & 0 & 0 \\ 1 & 0 & 0 & 0 & 0 & 1 & 0 & 0 & 0 & 0 & 0 & 0 \\ 1 & 0 & 0 & 0 & 0 & 0 & 1 & 0 & 0 & 0 & 0 & 0\end{matrix} ] .$$

19. The computer program of claim 17, further comprising transmitting a device-to-device discovery signal on subframe resources selected in accordance with the determined transmission pattern.

20. The computer program of claim 17, wherein the computer program is further configured to control a processor to perform a process, comprising:
forming a subset of transmission patterns in the dictionary such that a number of reception opportunities for any pair of patterns selected from the subset is larger than a number of reception opportunities between a pattern from the subset and a pattern outside the subset.
determining whether the transmission pattern is to be selected from the subset at least in part based on at least one of a user equipment detection condition and a location of a user equipment relative to the center or edge of a user equipment cluster.
